(19) United States
(12) Patent Application Publication
(10) Pub. No.: US 2021/0201854 A1
(43) Pub. Date: Jul. 1, 2021

(54) MOBILE CALIBRATION OF DISPLAYS FOR SMART HELMET

(71) Applicant: Robert Bosch GmbH, Stuttgart (DE)

(72) Inventors: Benzun Pious Wisely BABU, San Jose, CA (US); Zeng DAI, Santa Clara, CA (US); Shabnam GHAFFARZADEGAN, San Mateo, CA (US); Liu REN, Cupertino, CA (US)

(21) Appl. No.: 16/728,087

(22) Filed: Dec. 27, 2019

(51) Int. Cl. G09G 5/373; G06K 9/00

(52) U.S. Cl. CPC G09G 5/373; G06K 9/00268; G09G 2370/04; G09G 2354/00; G09G 2320/0693; G09G 2340/045

(57) ABSTRACT

A smart helmet includes a heads-up display (HUD) configured to output graphical images within a virtual field of view on a visor of the smart helmet. A transceiver is configured to communicate with a mobile device of a user. A processor is programmed to receive, via the transceiver, calibration data from the mobile device that relates to one or more captured images from a camera on the mobile device, and alter the virtual field of view of the HUD based on the calibration data. This allows a user to calibrate his/her HUD of the smart helmet based on images received from the user's mobile device.

### TECHNICAL FIELD

The present disclosure relates to intelligent helmets or smart helmets, such as those utilized while riding two-wheeler vehicles such as motorcycles and dirt bikes, three-wheeler vehicles, or four-wheeler vehicles such as all-terrain vehicles.

### BACKGROUND

Smart helmets may be utilized by riders of a powered two-wheeler (PTW). Smart helmets can utilize a heads-up display to display information on a transparent visor or shield of the helmet. The information is overlaid onto the real-world field of view, and appears in focus at the appropriate distance so that the rider can safely view digital information on the visor while safely maintaining focus on the path ahead.

### SUMMARY

In one embodiment, a smart helmet includes a heads-up display (HUD) configured to output graphical images within a virtual field of view on a visor of the smart helmet; a transceiver configured to communicate with a mobile device of a user; and a processor in communication with the transceiver and the HUD. The processor is programmed to receive, via the transceiver, calibration data from the mobile device that relates to one or more captured images from a camera on the mobile device, and alter the virtual field of view of the HUD based on the calibration data.

In another embodiment, a system for calibrating a heads-up display of a smart helmet includes a mobile device having a camera configured to capture an image of a face of a user; a smart helmet having a heads-up display (HUD) configured to display virtual images within a virtual field of view on a visor of the smart helmet; and one or more processors. The one or more processors configured to determine one or more facial characteristics of captured image of the face of the user; determine an offset value for offsetting the virtual field of view based on the one or more facial characteristics; and calibrate the virtual field of view based on the offset value to adjust a visibility of the virtual images displayed by the HUD.

In yet another embodiment, one or more non-transitory computer-readable media comprising executable instructions is provided, wherein the instructions, in response to execution by one or more processors, cause the one or more processors to: capture one or more digital images of a face of a user via a camera of a mobile device; determine a facial feature of the face based on the captured images; transmit a signal from the mobile device to a smart helmet, wherein the signal includes data relating to the facial feature of the face; receive the signal at the smart helmet; and calibrate a virtual field of view of a heads-up display of the smart helmet based on the received signal.

### BRIEF DESCRIPTION OF THE DRAWINGS

FIG. 1 is an example of a system design that includes a smart helmet and a saddle-ride vehicle such as a motorcycle.

FIG. 2 illustrates a block diagram of a calibration system performed to render virtual content in an optical see-through display, according to one embodiment.

FIG. 3 illustrates a schematic representation of one or more cameras of a mobile device capturing images of a face of a user for calibration of the optical see-through display, according to one embodiment.

FIG. 4 illustrates a block diagram of a mobile device utilized to correct the reference face structure model and correct the calibration parameters of the optical see-through display, according to one embodiment.

FIG. 5 illustrates a flow chart of a process performed via a communication link between the smart helmet and the mobile device, according to one embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

This disclosure makes references to helmets and saddle-ride vehicles. It should be understood that a “saddle-ride vehicle” typically refers to a motorcycle, but can include any type of automotive vehicle in which the driver typically sits on a saddle, and in which helmets are typically worn due to absence of a cabin for the protection of the riders. Other than a motorcycle, this can also include other powered two-wheeler (PTW) vehicles such as dirt bikes, scooters, and the like. This can also include a powered three-wheeler, or a powered four-wheeler such as an all-terrain vehicle (ATV) and the like. Any references specifically to a motorcycle can also apply to any other saddle-ride vehicle, unless noted otherwise.

Intelligent helmets or “smart helmets” for saddle-ride vehicles typically include a heads-up display (HUD), also referred to as an optical see-through display, that may be located on a visor of the helmet, for example. The HUD can display augmented reality (AR), graphical images including vehicle data, and other information that appears far away from the driver, allowing the driver to safely view the information while properly driving the vehicle. The source of the visual display in the HUD needs to be placed appropriately for proper viewing by the driver. Different drivers have different head sizes and different spaces between their eyes, which can affect the ability to properly view the information on the HUD amongst different drivers. However, due to manufacturing limitations, a generic or standard design suitable for most (but not all) users is designed for production.

Therefore, according to embodiments disclosed herein, a system is disclosed that utilizes a camera on a mobile device (e.g., smart phone) to capture images of the rider, whereupon these images can be analyzed for calibrating the HUD system in the smart helmet. For example, the generic design that comes pre-programmed and standard with the smart helmet can be calibrated to better suit the user's facial features based on communication with a mobile device that captures images of the user. Even though a smart helmet may come equipped with a camera that faces the user's face for purposes of calibrating the HUD system, this helmet camera may be too close to the user's face for proper calibration. Having a camera too close to the user's face can distort the image, stretching out the appearance of the user's face, for example. This can give an improper measurement of the dimensions and contours of the user's face, including the distance between the user's eyes, which can improperly impact the calibration process and overall functionality of the HUD system.

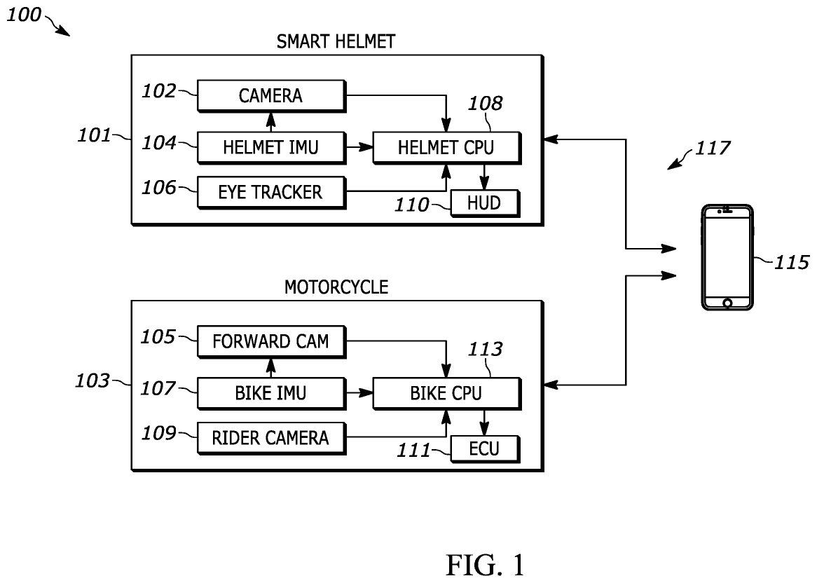

FIG. 1 is an example of a system 100 that includes a smart helmet 101 and a saddle-ride vehicle 103. The smart helmet 101 and saddle-ride vehicle 103 may include various components and sensors that interact with each other. The smart helmet 101 may focus on collecting data related to body and head movement of a driver. In one example, the smart helmet 101 may include a camera 102. The camera 102 of the helmet 101 may include a primary sensor that is utilized for position and orientation recognition in moving vehicles. Thus, the camera 102 may face outside of the helmet 101 to track other vehicles and objects surrounding a rider. In another example, the helmet 101 may be included with radar or LIDAR sensors, in addition to or instead of the camera 102.

The helmet 101 may also include a helmet inertial measurement unit (IMU) 104. The helmet IMU 104 may be utilized to track high dynamic motion of a rider's head. Thus, the helmet IMU 104 may be utilized to track the direction a rider is facing or the rider viewing direction. Additionally, the helmet IMU 104 may be utilized for tracking sudden movements and other issues that may arise. An IMU may include one or more motion sensors.

The IMU may measure and report a body's specific force, angular rate, and sometimes the magnetic field, using a combination of accelerometers and gyroscopes, sometimes also magnetometers. IMUs are typically used to maneuver aircraft, including unmanned aerial vehicles (UAVs), among many others, and spacecraft, including satellites and landers. The IMU may be utilized as a component of inertial navigation systems used in various vehicle systems. The data collected from the IMU's sensors may allow a computer to track a motor position.

The IMU may work by detecting the current rate of acceleration using one or more accelerometers, and detect changes in rotational attributes like pitch, roll and yaw using one or more gyroscopes. The IMU may also include a magnetometer, which may be used to assist calibration against orientation drift. Inertial navigation systems contain IMUs that have angular and linear accelerometers (for changes in position); some IMUs include a gyroscopic element (for maintaining an absolute angular reference). Angular rate meters measure how a vehicle may be rotating in space. There may be at least one sensor for each of the three axes: pitch (nose up and down), yaw (nose left and right) and roll (clockwise or counter-clockwise from the cockpit). Linear accelerometers may measure non-gravitational accelerations of the vehicle. Since it may move in three axes (up & down, left & right, forward & back), there may be a linear accelerometer for each axis. The three gyroscopes are commonly placed in a similar orthogonal pattern, measuring rotational position in reference to an arbitrarily chosen coordinate system. A computer may continually calculate the vehicle's current position. For each of the six degrees of freedom (x,y,z and Ox, Oy, and Oz), it may integrate over time the sensed acceleration, together with an estimate of gravity, to calculate the current velocity. It may also integrate the velocity to calculate the current position. Some of the measurements provided by an IMU are below:

\hat{a}_{B}=R_{BW}(a_{w}−g_{w})+bₐ+ηₐ

\hat{ω}_{B}=ω_{B}+b_{g}+η_{g}

where (â_{B}, \hat{ω}_{B}) are the raw measurements from the IMU in the body frame of the IMU. a_{w}, ω_{B} are the expected correct acceleration and the gyroscope rate measurements. bₐ, b_{g} are the bias offsets in accelerometer and the gyroscope. ηₐ, η_{g} are the noises in accelerometer and the gyroscope.

The helmet 101 may also include an eye tracker 106. The eye tracker 106 may be utilized to determine a direction of where a rider of the saddle-ride vehicle 103 is looking. The eye tracker 106 can also be utilized to identify drowsiness and tiredness or a rider of the PTW. The eye tracker 106 may identify various parts of the eye (e.g. retina, cornea, etc.) to determine where a user is glancing. The eye tracker 106 may include a camera or other sensor to aid in tracking eye movement of a rider.

The helmet 101 may also include a helmet processor 108. The helmet processor 108 may be utilized for sensor fusion of data collected by the various camera and sensors of both the saddle-ride vehicle 103 and helmet 101. In other embodiment, the helmet may include one or more transceivers that are utilized for short-range communication and long-range communication. Short-range communication of the helmet may include communication with the saddle-ride vehicle 103, or other vehicles and objects nearby. In another embodiment, long-range communication may include communicating to an off-board server, the Internet, “cloud,” cellular communication, etc. The helmet 101 and saddle-ride vehicle 103 may communicate with each other utilizing wireless protocols implemented by a transceiver located on both the helmet 101 and saddle-ride vehicle 103. Such protocols may include Bluetooth, Wi-Fi, etc.

The helmet 101 also includes a heads-up display (HUD) 110, also referred to as an optical see-through display, that is utilized to output graphical images on a transparent visor (for example) of the helmet 101. Various types of HUD systems can be utilized. In one embodiment, the HUD 110 is projection-based system, having a projector unit, a combiner, and a video generation computer. The projector unit can be an optical collimator setup, having a convex lens or concave mirror with a cathode ray tube, light emitting diode (LED) display, or liquid crystal display (LCD) at its focus. This design produces an image where the light is collimated, and the focal point is perceived to be at infinity. The combiner can be an angled flat piece of glass located directly in front of the viewer that redirects the projected image onto the transparent display so that the user can view the field of view and the projected image projected out to infinity

In another embodiment, the HUD 110 is a waveguide-based system in which optical waveguides produce images directly in the combiner rather than using a projector. This embodiment may be better suited for the small packaging constraints within the helmet 101, while also reducing the overall mass of the HUD compared to a projection-based system. In this embodiment, surface gratings are provided on the screen of the helmet itself (e.g., the visor). The screen may be made of glass or plastic, for example. A microprojector can project an image directly onto the screen, wherein an exit pupil of the microprojector is placed on the surface of the screen. A grating within the screen deflects the light such that the light becomes trapped inside the screen due to total internal reflection. One or two additional gratings can then be used to gradually extract the light, making displaced copies of the exit pupil. The resulting image is visible to the user, appearing at an infinity-length focal point, allowing the user to view the surroundings and the augmented reality or displayed data at the same time.

Other embodiments of the HUD 110 can be utilized. These embodiments include, and are not limited to, the utilization of a cathode ray tube (CRT) to generate an image on the screen which is a phosphor screen, the utilization of a solid state light source (e.g., LED) which is modulated by the screen (which is an LCD screen) to display an image, the utilization of a scanning laser to display an image on the screen, among other embodiments. Also, the screen may use a liquid crystal on silicon (LCoS), digital micro-mirrors (DMD), or organic light-emitting diodes (OLED).

The HUD 110 may receive information from the helmet CPU 108. The helmet CPU 108 may be connected to the saddle-ride vehicle 103 (e.g., transceiver-to-transceiver connection, or other short-range communication protocols described herein) such that various vehicular data can be displayed on the HUD. For example, the HUD 110 may display for the user the vehicle speed, the fuel amount, blind-spot warnings via sensors on the vehicle 103, turn-by-turn navigation or GPS location based on a corresponding system on the vehicle 103, etc. The HUD 110 may also display information from the mobile device 115 as transmitted via the link 117, such as information regarding incoming/outgoing calls, directions, GPS and locational information, health monitoring data from a wearable device (e.g., heartrate), etc.

The saddle-ride vehicle 103 may be in communication with the smart helmet 101 via, for example, a short-range communication link as explained above. The saddle-ride vehicle 103 may include a forward-facing camera 105. The forward-facing camera 105 may be located on a headlamp or other similar area of the saddle-ride vehicle 103. The forward-facing camera 105 may be utilized to help identify where the PTW is heading. Furthermore, the forward-facing camera 105 may identify various objects or vehicles ahead of the saddle-ride vehicle 103. The forward-facing camera 105 may thus aid in various safety systems, such as an intelligent cruise control or collision-detection systems.

The saddle-ride vehicle 103 may include a bike IMU 107. The bike IMU 107 may be attached to a headlight or other similar area of the PTW. The bike IMU 107 may collect inertial data that may be utilized to understand movement of the bike. The bike IMU 107 may be a multiple axis accelerometer, such as a three-axis, four-axis, five-axis, six-axis, etc. The bike IMU 107 may also include multiple gyros. The bike IMU 107 may work with a processor or controller to determine the bike's position relative to a reference point, as well as its orientation.

The saddle-ride vehicle 103 may include a rider camera 109. The rider camera 109 may be utilized to keep track of a rider of the saddle-ride vehicle 103. The rider camera 109 may be mounted in various locations along a handlebar of the saddle-ride vehicle, or other locations to face the rider. The rider camera 109 may be utilized to capture images or video of the rider that are in turn utilized for various calculations, such as identifying various body parts or movement of the rider. The rider camera 109 may also be utilized to focus on the eyes of the rider. As such, eye gaze movement may be determined to figure out where the rider is looking.

The saddle-ride vehicle 103 may include an electronic control unit 111. The ECU 111 may be utilized to process data collected by sensors of the saddle-ride vehicle, as well as data collected by sensors of the helmet. The ECU 111 may utilize the data received from the various IMUs and cameras to process and calculate various positions or to conduct object recognition. The ECU 111 may be in communication with the rider camera 109, as well as the forward-facing camera 105. For example, the data from the IMUs may be fed to the ECU 111 to identify position relative to a reference point, as well as orientation. When image data is combined with such calculations, the bike's movement can be utilized to identify where a rider is facing or focusing on. The image data from both the forward-facing camera on the bike and the camera on the helmet are compared to determine the relative orientation between the bike and the riders head. The image comparison can be performed based on sparse features extracted from both the cameras (e.g., rider camera 109 and forward-facing camera 105). In one embodiment, the saddle-ride vehicle 103 includes a bike central processing unit 113 in communication with the ECU 111. The system may thus continuously monitor the rider attention, posture, position, orientation, contacts (e.g., grip on handlebars), rider slip (e.g., contact between rider and seat), rider to vehicle relation, and rider to world relation.

Either one or both of the smart helmet 101 and the saddle-ride vehicle 103 may be in communication with a mobile device 115 via a communication link 117 or network. The mobile device 115 may be or include a cellular phone, smart phone, tablet, or a smart wearable device like a smart watch, and the like. The wireless communication link 117 may facilitate exchange of information and/or data. In some embodiments, one or more components in the smart helmet 101 and/or the saddle-ride vehicle 103 (e.g., controllers 108, 111, 113) may send and/or receive information and/or data to the mobile device 115. For example, the helmet CPU 108 or other similar controller may receive information from the mobile device 115 to offset or recalibrate the commands send to the HUD 110 for display on the transparent visor of the helmet 101. To perform the exchange, the smart helmet and/or the saddle-ride vehicle may be equipped with a corresponding transceiver configured to communicate with a transceiver of the mobile device 115. In some embodiments, the wireless communication link 117 may be any type of wired or wireless network, or combination thereof. Merely by way of example, the wireless communication link 117 may include a cable network, a wireline network, an optical fiber network, a telecommunications network, an intranet, an Internet, a local area network (LAN), a wide area network (WAN), a wireless local area network (WLAN), a metropolitan area network (MAN), a wide area network (WAN), a public telephone switched network (PSTN), short-range communication such as a Bluetooth™ network, a ZigBee™ network, or the like, a near field communication (NFC) network, a cellular network (e.g., GSM, CDMA, 3G, 4G, 5G), or the like, or any combination thereof. In some embodiments, the wireless communication link 117 may include one or more network access points. For example, the wireless communication link 117 may include wired or wireless network access points such as base stations and/or internet exchange points through which one or more components of the smart helmet 101 and/or saddle-ride vehicle 103 may be connected to the wireless communication link 117 to exchange data and/or information.

Various processing units and control units are described above, as being part of the smart helmet 101 or the saddle-ride vehicle 103. This includes the helmet CPU 108, the bike CPU 113, and the ECU, for example. These processing units and control units may more generally be referred to as a processor or controller, and can be any controller capable of receiving information from various hardware (e.g., from a camera, an IMU, etc.), processing the information, and outputting instructions to the HUD 110, for example. In this disclosure, the terms “controller” and “system” may refer to, be part of, or include processor hardware (shared, dedicated, or group) that executes code and memory hardware (shared, dedicated, or group) that stores code executed by the processor hardware. The code is configured to provide the features of the controller and systems described herein. In one example, the controller may include a processor, memory, and non-volatile storage. The processor may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory. The memory may include a single memory device or a plurality of memory devices including, but not limited to, random access memory (“RAM”), volatile memory, non-volatile memory, static random-access memory (“SRAM”), dynamic random-access memory (“DRAM”), flash memory, cache memory, or any other device capable of storing information. The non-volatile storage may include one or more persistent data storage devices such as a hard drive, optical drive, tape drive, non-volatile solid-state device, or any other device capable of persistently storing information. The processor may be configured to read into memory and execute computer-executable instructions embodying one or more software programs residing in the non-volatile storage. Programs residing in the non-volatile storage may include or be part of an operating system or an application, and may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL. The computer-executable instructions of the programs may be configured, upon execution by the processor, to cause an alteration, offset, or calibration of the HUD system based on information provided by a mobile device 115 via communication link 117, for example.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs embodied on a tangible medium, i.e., one or more modules of computer program instructions, encoded on one or more computer storage media for execution by, or to control the operation of, a data processing apparatus. A computer storage medium can be, or be included in, a computer-readable storage device, a computer-readable storage substrate, a random or serial access memory array or device, or a combination of one or more of them. The computer storage medium can also be, or be included in, one or more separate components or media (e.g., multiple CDs, disks, or other storage devices). The computer storage medium may be tangible and non-transitory.

A computer program (also known as a program, software, software application, script, or code) can be written in any form of programming language, including compiled languages, interpreted languages, declarative languages, and procedural languages, and the computer program can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, libraries, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., a field programmable gate array (“FPGA”) or an application specific integrated circuit (“ASIC”). Such a special purpose circuit may be referred to as a computer processor even if it is not a general-purpose processor.

In order to render virtual content on the HUD, calibration should be performed. During calibration, the spatial transformation between the different elements in the system is estimated. The required spatial transformation can be divided into two categories: (1) transformations associate with rigid bodies within the helmet, and (2) transformations associated with the user's face and the helmet. The transformations that are not depended on the user's facial structure can be performed at the factory or manufacturer of the helmet, prior to entering the hands of the user. However, the transformations associated with the user facial structure will have to be estimated before use by the user. Even though a smart helmet may come equipped with a camera that faces the user's face for purposes of calibrating the HUD system, this helmet camera may be too close to the user's face for proper calibration. This disclosure contemplates utilizing the mobile device 115 for such calibrations, yielding improved results by using one or more cameras remote from the helmet 101 but nonetheless in communication with the helmet 101.

The disclosed calibration system estimates the transformation between the user's eyes and the screen of the HUD to accurately render and display the virtual content. Since each user's facial structure is different, the calibration is performed per-user. The results of the calibration are used to adjust the overscan buffers on the HUD screen (e.g., waveguides) and to adjust the virtual camera rendering parameters.

The per-user calibration may be performed at home by the user. In short, an application (“app”) on a mobile device (e.g., smart phone) is used to collect images of the user's face via the camera of the mobile device to create a facial structure model of the user's face. This model is transmitted to the smart helmet 101 to correct the overscan offsets and the projection parameters. The user can also adjust the projection parameters using a touch interface on the mobile device to fine-tune the settings based on the user needs.

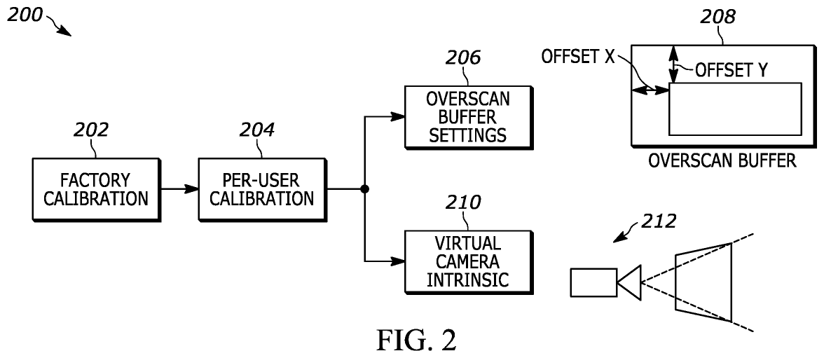

FIG. 2 illustrates one example of an overall summary of the calibration system 200 performed to render virtual content on the HUD of the smart helmet. The factory calibration is provided at 202, directly from the manufacturer or supplier of the helmet 101. The user can then calibrate the settings on a per-user basis at 204. The calibration can correct the overscan buffer settings at 206, including a correction to offsets at 208 including the horizontal offsets (“Offset x”) and vertical offsets (“Offset y”). In particular, the standard viewing display region provided by the helmet manufacturer to accommodate for the various head sizes and interpupillary distance (IPD) of the various users. The wide viewing region in the HUD can allow various head sizes and IPDs to be able to view the images at a perceived focal point of infinity, but the wide viewing region also can degrade quality and accuracy of the location of the data displayed on the screen.

The projection device (e.g., the light source, the waveguides, etc.) can create a virtual field of view of virtual images or graphical images on the screen (e.g., visor) of the helmet. As is typical in HUD systems, the virtual field of view can only be viewable when the user's eyes are at a proper location. For example, if the user's eyes are too high, too low, too far to either lateral side, or too far apart or close to one another from where the eyes are assumed to be in the pre-programmed system, the graphical images on the screen are either not viewable by the user, are distorted, or are not overlapping the real-life view at a proper location. To accommodate for the various head sizes, shapes, IPD, etc. of various users, the projection device and associated structure is pre-programmed to provide a wider-than-necessary virtual field of view. However, by having a wider-than-necessary virtual field of view, the user may be presented with graphical images that do not accurately overlay the real-life field of view, or may make the virtual images non-viewable for a particular user that may have facial characteristics outside of the pre-programmed boundaries of the helmet. By adjusting the vertical and horizontal offsets based on the known head size, shape, and IPD of the user from the mobile device, the viewing region on the HUD can be reduced. This can improve the quality and accuracy of the data, allowing, for example, the data (e.g., the color surrounding the vehicle in view) to be properly located on the HUD screen. This can also be very difficult to do with any camera or sensing device on-board the helmet, due to the structural constraints of the helmet. In some embodiment of the optical display unit for the glasses the light source projector and the optical coupler can be adjusted electronically or mechanically to change the HUD display region. To adjust the offsets, for example, the controller can move the glasses in the light source projector, and/or the optical coupler via an electrical or mechanical adjustment mechanism.

The per-user calibration can also correct the virtual camera intrinsic at 210, including a correction of the projection parameters of the light source of the HUD at 212. The projection parameters are used to transform a reference virtual object to a correctly focused display image on the HUD. In order to correct images with a correct focus and correct size, the projection parameters should consider the eye location. The projection parameters are modeled using a virtual camera that is placed at the eye center of the HUD user. The virtual cameras projection parameters are determined based on the IPD and measurements extracted from the users face.

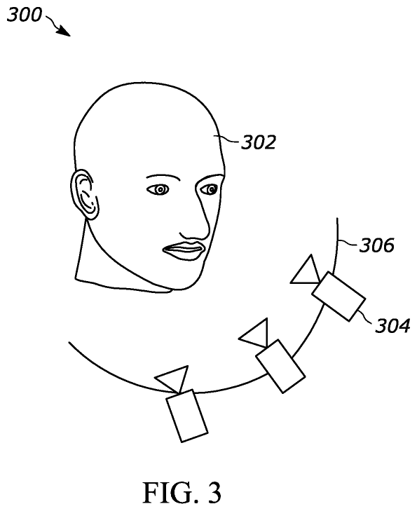

FIG. 3 illustrates a schematic use of an app of a mobile device to perform a facial scan of the user for calibration correction purposes, shown generally at 300. The helmet-calibration app on the mobile device can be opened by the user 302, which activates the camera 304 on the mobile device for integration with the app. With the camera 304 active, the user 302 can hold the mobile device at arm's length, facing the user's face, and move the mobile device along a path 306 about the user's face. This allows the camera to capture a sequence of images of the user's face. The screen of the mobile device can be used to provide feedback of the motion, thus guiding the user as he performs an arc motion along the path 306. The user can move the mobile device along the path 306 to capture images from multiple angles, elevations, etc.

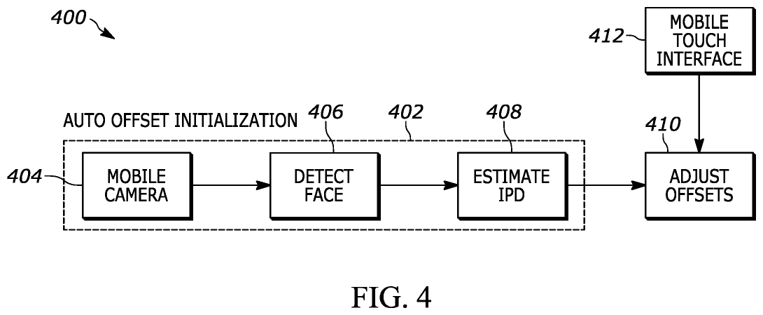

The app on the mobile device can calculate head shape, size, depth, and features such as IPD or depth to eyes by analyzing the captured images. The mobile device can calculate a calibration offset (e.g., a value to adjust the Offset x and Offset y), or can push this data to the helmet for calibration offsets to be performed by the helmet CPU. FIG. 4 shows an example embodiment of a flow chart of a system 400 for adjusting the offsets (e.g., viewable area of the virtual images provided by the light source of the helmet). An auto offset initialization sequence 402 can be performed by the mobile device. In particular, the application of the mobile device is initiated at 404, whereupon the camera is activated and used to detect a user's face at 406. This may be done by detecting an outline of the user's face, corresponding to a database of pre-programmed facial shapes to find a match, thereby confirming that the camera is capturing a face. This step may include utilizing the camera to detect pupils of the user's eyes, by similar methods of comparing the captured images to a pre-programmed database of faces with pupils, for example. At 408, the controller of the mobile device measures the distance between the pupils, to estimate an IPD.

The determined or estimated IPD can be fed to an adjustment offset feature at 410. The adjustment offset feature can modify the Offset x and Offset y of the virtual field of view of the HUD, as explained above. In one embodiment, a lookup table if provided and accessed by the controller of the mobile device or helmet that corresponds an Offset x and Offset y with an IPD. The Offset x and Offset y can also be adjusted based on the other detected features from the camera of the mobile device, such as the distance between the eyes and the visor, the distance between the top of the head and the eyes, etc. This step may be performed by the controller on the mobile device, or the controller in the helmet.

At 412, a mobile touch interface is provided by the app on the mobile device accessed by the user. In this step, the app can provide manual adjustment of the offsets. In the event the camera and associated software of the mobile device does not result in a proper virtual field of view for the user, the mobile touch interface can be accessed by the user for manual adjustment of the offsets until the virtual data is properly viewable by the user.

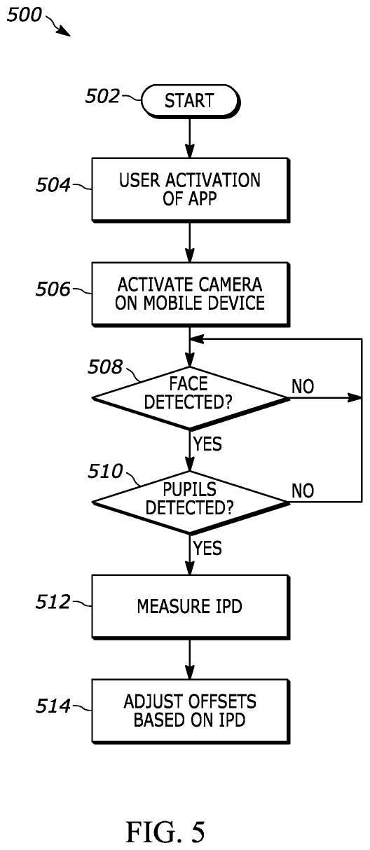

FIG. 5 illustrates an example flow chart of an algorithm 500 to be performed by one or more of the controllers described herein. The process begins at 502. At 504, the mobile device detects that a user has activated the application for adjustment of the HUD display. This can be done by selecting an app on the touch screen of the mobile device, for example. In response to the activation of the app, the camera on the mobile device may be activated or woken up at 506 so that the camera is prepared to capture images.

Via the app, the camera captures images of the user's face, and the controller on-board the mobile device determines whether a face is detected at 508. This can be done according to the methods described above, including, for example, comparing an outline of the captured face to a database of outlines. If a face is detected at 508, the controller on-board the mobile device determines whether pupils are detected at 510. This can be done according to the methods described above, including, for example, comparing an outline of a face with pupils or an outline of pupils relative to a face compared to a database of such outlines or images. With a positive identification of pupils, the controller can measure the IPD at 512. At 514, the adjustments of the offsets are determined based on the IPD, according to the methods described above. This can include, for example, accessing a lookup table that correlates IPDs to an Offset x and an Offset y, to adjust the virtual field of view. The offsets can be pushed to the helmet, whereupon the helmet CPU 108 can adjust the HUD 110 to accommodate the offsets and change the virtual field of view. The adjustment in offset can also be provided manually, via the mobile touch interface.

Steps 502-514 can be performed by the camera and controller on-board the mobile device. However, in other embodiments, the communication between the helmet and the mobile device can enable data to be shared and processing steps split between the mobile device and the helmet. In yet other embodiments, the image captured by the mobile device can be sent to an offsite database via a wireless network (e.g., the cloud), whereupon processing can occur, and the calibration instructions can be sent from the cloud to the helmet.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

1. A smart helmet comprising:
a heads-up display (HUD) configured to output graphical images within a virtual field of view on a visor of the smart helmet;
a transceiver configured to communicate with a mobile device of a user; and
a processor in communication with the transceiver and the HUD, and programmed to:
receive, via the transceiver, a facial structure model of a face of the user created by one or more captured images from a camera on the mobile device,
determine calibration data based on the facial structure model, and
alter the virtual field of view of the HUD based on the calibration data.

2. The smart helmet of claim 1, wherein the calibration data includes data indicating a size of the face of the user.

3. The smart helmet of claim 1, wherein the calibration data includes an interpupillary distance of the user.

4. The smart helmet of claim 1, wherein the mobile device includes a processor coupled to the camera and configured to determine an interpupillary distance, and the calibration data received by the processor of the smart helmet is based on the interpupillary distance.

5. The smart helmet of claim 1, wherein the processor is programmed to alter a horizontal dimension and a vertical dimension of the virtual field of view based on the calibration data.

6. (canceled)

7. The smart helmet of claim 1, wherein the processor is configured to adjust a light source projector based on the calibration data to alter the virtual field of view of the HUD.

8. A system for calibrating a heads-up display of a smart helmet, the system comprising:
a mobile device having a camera configured to capture images of a face of a user;
a smart helmet having a heads-up display (HUD) configured to display virtual images within a virtual field of view on a visor of the smart helmet;
one or more processors configured to:
create a facial structure model of the face of the user based on the captured images;
determine one or more facial characteristics of the user based on the facial structure model;
determine an offset value for offsetting the virtual field of view based on the one or more facial characteristics; and
calibrate the virtual field of view based on the offset value to adjust a visibility of the virtual images displayed by the HUD.

9. The system of claim 8, wherein the one or more facial characteristics includes an interpupillary distance of the user.

10. The system of claim 9, wherein the one or more processors is configured to access a lookup table to determine the offset value based on the interpupillary distance.

11. The system of claim 8, wherein the offset value includes a horizontal offset and a vertical offset.

12. The system of claim 11, wherein the virtual field of view is pre-programmed, and horizontal offset and the vertical offset are configured to shrink the pre-programmed virtual field of view upon calibration.

13. The system of claim 8, wherein the one or more processors is configured to adjust a light source projector based on the offset value to calibrate the virtual field of view.

14. One or more non-transitory computer-readable media comprising executable instructions, wherein the instructions, in response to execution by one or more processors, cause the one or more processors to:
capture one or more digital images of a face of a user via a camera of a mobile device;
create a facial structure model of the face of the user based on the captured images;
determine a facial feature of the face based on the facial structure;
transmit a signal from the mobile device to a smart helmet, wherein the signal includes data relating to the facial feature of the face;
receive the signal at the smart helmet; and
calibrate a virtual field of view of a heads-up display of the smart helmet based on the received signal.

15. The one or more non-transitory computer-readable media of claim 14, wherein the facial feature includes an interpupillary distance.

16. The one or more non-transitory computer-readable media of claim 14, wherein the instructions further cause the one or more processors to apply a vertical offset value and a horizontal offset value to the virtual field of view to calibrate the virtual field of view.

17. The one or more non-transitory computer-readable media of claim 16, wherein the instructions further cause the one or more processors to shrink the virtual field of view to apply a vertical offset value and a horizontal offset.

18. The one or more non-transitory computer-readable media of claim 14, wherein the instructions further cause the one or more processors to adjust a light source projector based on the received signal to calibrate the virtual field of view.

19. The one or more non-transitory computer-readable media of claim 14, wherein the virtual field of view is initially pre-programmed onto the one or more non-transitory computer-readable media.

20. The one or more non-transitory computer-readable media of claim 14, wherein the calibration of the virtual field of view alters the pre-programmed virtual field of view.

21. The smart helmet of claim 2, wherein the calibration data includes a distance between a top of the user's head and eyes of the user.
